(19) United States
(12) Patent Application Publication
(10) Pub. No.: US 2017/0019546 A1
(43) Pub. Date: Jan. 19, 2017

(54) METHOD AND SYSTEM TO PROVIDE AN ACCESSIBILITY USER INTERFACE

(71) Applicant: Xerox Corporation, Norwalk, CT (US)

(72) Inventors: Francis K. Tse, Rochester, NY (US); Michael H. Wang, Macedon, NY (US); Samkit Jain, Bediya (IN); Deepak Ravishankar Ramkumar, Buffalo, NY (US); Amrita Shailini Diol, Rochester, NY (US); Surya Prakash Kotha, Chennai (IN); Giuseppe Pandolfo, Rochester, NY (US); Premkumar Rajendran, Fairport, NY (US); Marlon D. Miller, Purcellville, VA (US); Karthikeyan Sundaramoorthy, Thanjavur (D.t) (IN); Lakshmi Kothandapani, Chennai (IN); Vidya Kanigiluppai Sivasubramanian, Chennai (IN)

(21) Appl. No.: 14/797,776

(22) Filed: Jul. 13, 2015

(51) Int. Cl. H04N 1/00

(52) U.S. Cl. CPC H04N 1/00506; H04N 1/00204; H04N 1/00392; H04N 1/00403; H04N 1/00474; H04N 1/0083; H04N 2201/0094

(57) ABSTRACT

This disclosure provides a method and system of providing a supplemental user interface (UI) operatively associated with a device, such as a multifunctional device (MFD) or multifunctional printer (MFP). According to an exemplary embodiment of this disclosure, an accessibility UI is provided by a portable computer device, e.g., off-the-shelf tablet, where the table includes a container application including a collection of walk-up user applications to operate the MFD, a set of tablet user environment' configuration applications and a set of helper applications that operate in the background and/or provide transitory screens, such as authentication for operating the MFD.

### BACKGROUND

Illustrated herein are embodiments of a printer/copier having a flexible User Interface suitable for use by users having disabilities affecting the movement of their hands and/or fingers. The embodiments disclosed herein find particular application in conjunction with printer/copiers and MFD (Multifunction Devices) will be described with particular reference thereto. However, it is to be appreciated that these embodiments are also amenable to other like applications.

Copiers capable of copying documents are widely used at both the home and workplace. Similarly, printers capable of forming hardcopy images are also in wide use today. Multifunction machines often combine the functionality of printers and copiers and perhaps other machines including but not limited to fax machines, and scanners and the like.

Printer/copiers, which can be printers, copiers or multifunction machines, typically include a User Interface located on these machines which enables the user to operate them. The User Interface typically includes buttons which the user pushes for selecting desired machine functions or inputting information, such as the number of copies desired. Accompanying these hard keys will typically be a screen which will display the current options to the user, this screen may also be able to respond to touch in order to select/confirm options. The GUI will typically display advanced options for programming copy/print jobs, e.g. stapled output selection, output paper size, etc., the basic functions, i.e., keypad entry for number of copies required and the “Start Job” button being provided by hard keys.

Although a wide variety of different User Interfaces are known, these interfaces require a level of manual dexterity which does not accommodate users having disabilities affecting the movement of the hand and fingers to operate them. Disabled persons having limited manual dexterity have trouble pressing the rather small buttons needed for operating these machines. It is desirable to provide printer/copiers that can accommodate those with limited manual dexterity so that they can operate these machines.

In current office Multifunction Printers (MFD), the user interface (UI) is typically designed as an integral part of the printer. Many times, the UI can be designed as a dumb display terminal with the logic and smarts embedded in the main controller of the MFD making it difficult to add new UI features and functions. In the past, this would have been required to minimize the hardware (HW) cost of the MFD. As cost of touch screen based smart tablets comes down, a new UI architecture is needed to replace the embedded UI to be able to response to new requirements such as Section 508 compliance for handicap users.

### INCORPORATION BY REFERENCE

U.S. Publication No. 2006/0290962, published 12-28-2006, by Lynn et al., entitled “PRINTER/COPIER HAVING UNIVERSAL POINTING DEVICE INTERFACE”;

Wikipedia—Ethernet over USB, en.wikipedia.org/wiki/Ethernet_over_USB, 3 pages;

5 Free Android Apps to Tethering; mashable.com/2012/08/16/free-tethering-apps/, 4 pages;

All you need to know about tethering with your Android device, www.androidauthority.com/what-is-tethering-android-280456/, 9 pages;

What is Tethering? [Android A to Z]; www.androidcentral.com/what-tethering-android-z, 19 pages;

Wikipedia—Tethering; en.wikipedia.org/wiki/Tethering, 4 pages; and

Dynamic Host Configuration Protocol, en.wikipedia.org/wiki/Dynamic_Host_Configuration_Protocol, 19 pages, are incorporated herein by reference in their entirety.

### BRIEF DESCRIPTION

In one embodiment of this disclosure, described is a computer-implemented method of operating a multifunction printer (MFD) including one or more of a copy function, scanner function, email function, fax function, and print function, the MFD including a primary user interface (UI) and a portable computing device functioning as a supplemental UI operatively associated with the primary user interface, the method comprising: operatively connecting the portable computing device to the MFD; and the portable computing device displaying a home screen associated with a container application, the container application including the home screen and a collection of applications associated with one or more of the copy functions, scanner functions, email functions, fax functions, and print functions; wherein the container application is configured to provide a user with no access to other functions of the portable computing device not associated with the container application.

In another embodiment of this disclosure, described is a multifunction device (MFD) comprising: a primary user interface (UI) configured to provide a user with control of one or more of a copy function, scanner function, fax function, and print function; one or more processers and associated memory configured to execute the one or more of the copy function, scanner function, fax function, and print function; a portable computing device operatively associated with the MFD, the portable computing device configured to display a home screen associated with a container application, the container application including the home screen and a collection of applications associated with one or more of the copy function, scanner function, email function, fax function, and print function, wherein the container application is configured to provide the user with no access to other functions of the portable computing device not associated with the container application.

In still another embodiment of this disclosure, described is a portable computing device operatively associated with a multifunction device (MFD) including one or more of a copy function, scanner function, email function, fax function, and print function, the portable computing device comprising: one or more processors and operatively associated memory storing instructions to the one or more processors configured to execute the stored instructions to display a home screen associated with a container application, the container application including the home screen and a collection of applications associated with one or more of the copy function, scanner function, email function, fax function, and print function; wherein the container application is configured to provide a user with no access to other functions of the portable computing device not associated with the container.

### BRIEF DESCRIPTION OF THE DRAWINGS

FIG. 1 is a block diagram of a multifunction device (MFD) including a primary user interface (UI) and associated supplemental UI according to an exemplary embodiment of this disclosure.

FIG. 2 is another block diagram of a multifunction device (MFD) including a primary user interface (UI) and associated supplemental UI according to an exemplary embodiment of this disclosure.

FIG. 3 is a home screen associated with a supplemental collection of applications associated with a container according to an exemplary embodiment of this disclosure.

FIG. 4 is a copy application display screen associated with the supplemental UI according to an exemplary embodiment of this disclosure, the copy application display screen including scrollable parameter selection bars.

FIG. 5 is a Common Access Card (CAC) login application blocking screen associated with the supplemental UI according to an exemplary embodiment of this disclosure.

FIG. 6 is a soft keyboard associated with a supplemental UI according to an exemplary embodiment of this disclosure.

FIG. 7 is an illustration of an accessibility connection of a portable computing device, such as a tablet, serving as a supplemental UI to control a MFD according to an exemplary embodiment of this disclosure.

FIG. 8 is an illustration including a front view of a supplemental UI, i.e., Accessibility UI, mounted to a MFD according to an exemplary embodiment of this disclosure.

FIG. 9 is an illustration including a rear view of a supplemental UI, i.e., Accessibility UI, mounted to a MFD according to an exemplary embodiment of this disclosure.

FIG. 10 is a home screen associated with an Accessibility UI according to an exemplary embodiment of this disclosure, where a Device Application is launched by a user.

FIG. 11 illustrates a login screen displayed on the Accessibility UI after a user launches the Device Application according to an exemplary embodiment of this disclosure.

FIG. 12 illustrates a web browser interface associated with a MFD, the web browser interface accessible via an Accessibility UI according to an exemplary embodiment of this disclosure.

### DETAILED DESCRIPTION

This disclosure provides a method and system including mobile apps running on an off-the-shelf tablet type device that is operatively connected to a multifunction printer (MFP) to provide an accessible UI (user interface) for handicapped users of the MFP. The system software includes three components: a collection of walk-up user apps that are configured for a handicapped user to operate the MFD with the ability to modify one or more operating parameters of the MFD; a set of tablet user environment configuration apps; and a set of helper apps that work in the background or provide transitory screens, such as authentication to the MFD. The default operating parameters on the Accessibility UI can be different from the MFD's defaults. The system exposes those MFD capabilities that are most beneficial to handicapped users. An external keyboard can be used to interact with the accessibility UI. The system may also include different interfaces for different types of handicaps, e.g., visually impaired vs. wheelchair-bound. In addition to different appearances of the interface, the defaults of the interface can be oriented to the needs of the user, inferred by how the user is accessing it.

With the rapid evolution and adoption of the mobile devices, many user interaction interfaces are made available at a relatively low cost. Interfaces such as microphone, speaker, capacitive touch screen, keyboards, etc., are commonly supported. Many tablet features/functions have options to enable ease of use of the tablets including for the handicapped users.

For example, iOS® VoiceOver© and Android© Talkback© allow blind and visually impaired users to navigate and use apps on their respective mobile platforms. Both iOS® and Android© devices support triple-tapping to magnify the current screen with full pinching to magnify and multiple finger gestures to scroll around the screen. The method and system disclosed make use of an Android© tablet as an UI to interact with an MFD making use of all the tablet's built-in accessibility features. However, it is to be understood the exemplary embodiments disclosed can also be implemented with other portable computing devices and other operating systems.

While many mobile apps are available to perform office functions, the method and system provided herein use a set of individual apps organized into groups of functions to provide a handicapped user a UI for an operatively connected MFD. According to one exemplary embodiment, the accessibility UI includes three groups of apps. There is a first collection of apps that provides the main accessibility UI; and a second collection of apps that allows a System Administration to set up the tablet and to manage the MFD. The second collection of apps are not intended to be used by the handicapped users since use of the MFD maintenance screens might lead to access of non-handicap friendly areas on the MFD. Finally, a third set of helper apps is provided that work in the background or provide transitory screens, such as authentication to the MFD.

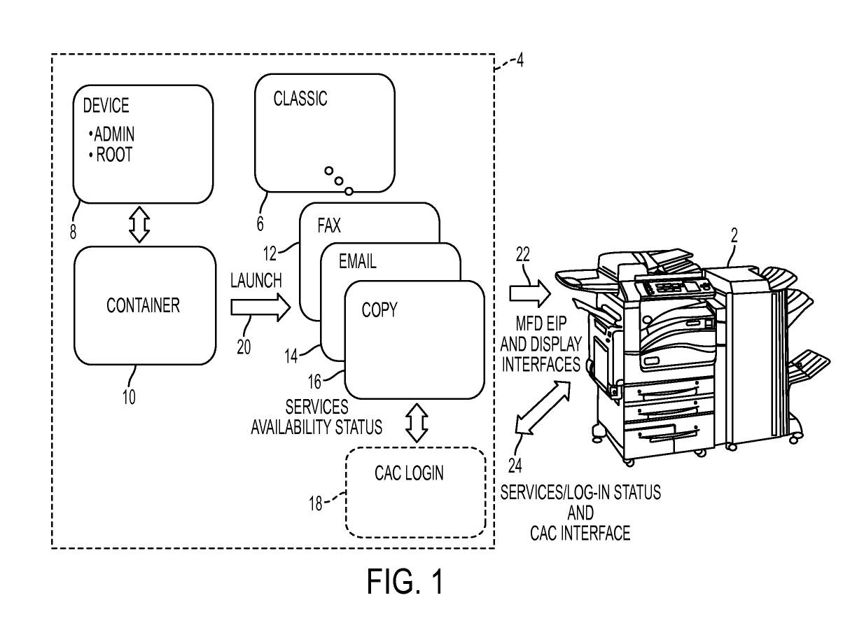

FIG. 1 shows the apps that have been implemented in a current MFD 2 Accessibility Solution 4. Classic block 6, Fax block 12, Email block 14, Copy block 16 and Container block 10 are the basic Accessibility UI apps. Device block 8 is a tablet control/setup app and CAC Login block 18 is a helper app.

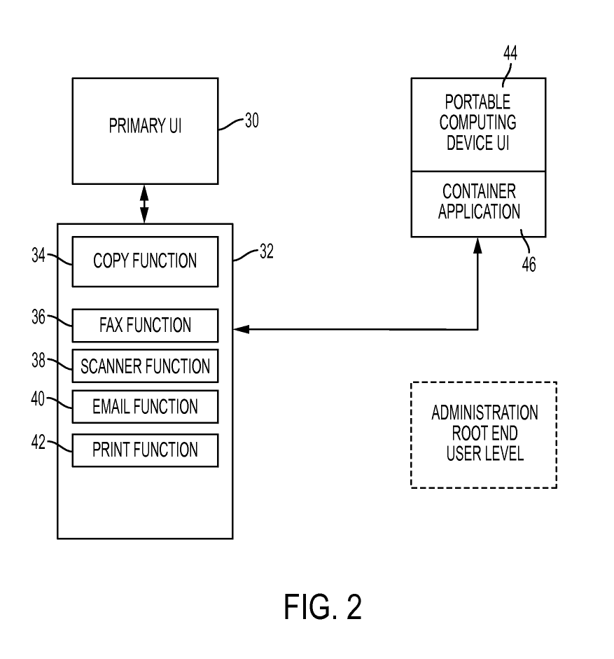

FIG. 2 is another block diagram of a multifunction device (MFD) including a primary user interface (UI) and associated supplemental UI according to an exemplary embodiment of this disclosure. The MFD 32 provides access via the Primary UI 30, to services including Copy 34, Fax 36 and Email 40. All these services use the Scanner 38. In addition, from the Primary UI a walk up user could avail of Print 42. The user requiring additional access could avail of the Portable UI 44, and all the services made available through Container 46, in lieu of using Primary UI 30. Container 46 is open to the handicapped user with special needs. Flexibility is provided via Administration access at the portable device 44 to configure the Container 46 to match the configuration of MFD 32. Flexibility of control is provided via different levels of access. Administration access at the portable device 44 is used to configure the Container 46 to apply to the User access level functions such as use of external keyboard and Authentication CAC helper app. Root access to the Portable device 44 is used to set up and allow full access of the Portable device 44 to function solely as an Accessible User Interface to the MFD 32, by way of Container 46. Portable device 44 is physically connected via USB to MFD 32.

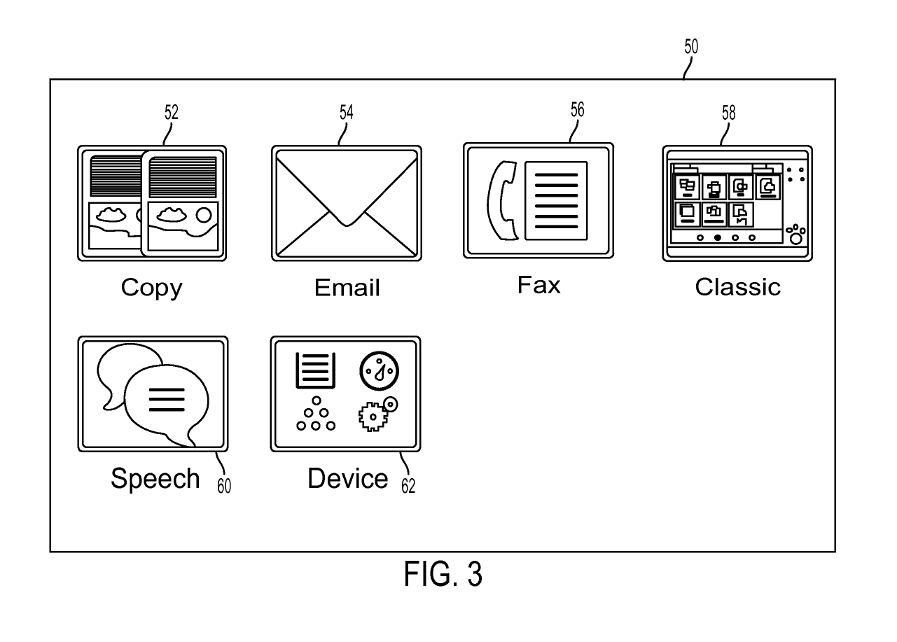

The set of apps that makes up the main Accessibility UI consists of a container app 10 that displays a Home screen of the UI. In the container app screen 50, displayed are the selectable apps in the current implementation as shown in FIG. 3, according to an exemplary example.

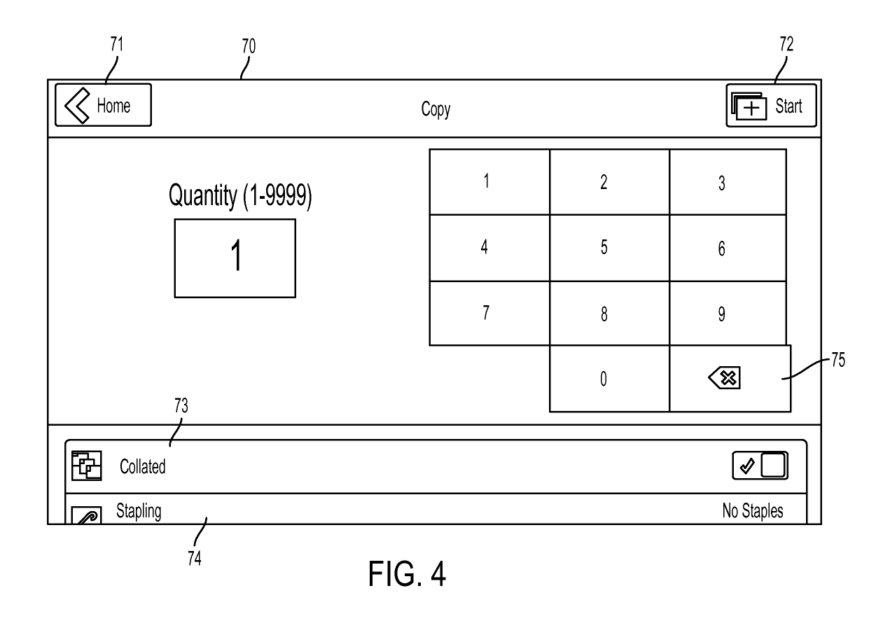

All the apps, i.e., Copy app 52, Email app 54, Fax app 56, Classic app 58, except for the Device app 62, allow a handicapped user to operate the MFD and select operating parameters such as copy count, collation, stapling, etc. FIG. 4 shows how a copy screen 70 looks like when a user taps on the Copy button (icon).

With the Talkback accessibility turned on, audible announcements are made as a blind user glides their fingers over the screen. A button, i.e., one of icons 71-75, can be selected when a user's finger stops over it, in addition to the numerals corresponding to a copy count. Double tapping will select the button and launch the corresponding app. On the Copy screen, for example, a blind user can glide over the screen to hear the current copy count setting and current copy parameter settings. Double tapping after a parameter is selected will open a parameter where setting options are announced and again the user can glide the finger over the selections and choose it by double tapping to confirm selection.

As previously described, FIG. 3 shows a set of apps consisting of Copy, Email, Fax, Classic and Speech. These apps are designed to provide their own independent functionality and implementation such as operating the basic MFD copy and scan to email functions. In addition, there can be composite apps such as the FAX app making use of the scan and print back capabilities of the MFD to implement Fax functions. The classic app uses VNC calls to display the MFD's local UI remotely on the tablet's screen allowing sighted but wheelchair bound users to access all local UI functionalities. The Speech app allows a user to talk to the tablet to tell the MFD what to do.

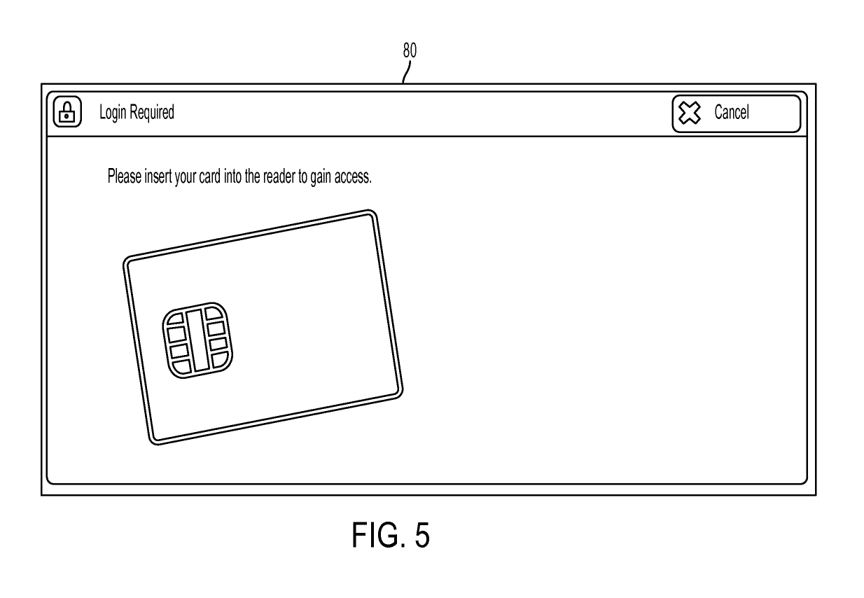

What is not shown on the Home screen 50 are the helper apps, such as the CAC login app. The helper apps work in the background and provide transitory screens, such as assist in logging in to the MFD. FIG. 5 shows one of the screens that the CAC login app displays to instruct a user to log in when a user wants to launch a service that requires CAC access authentication. Audible instructions guide the user through the authentication process.

Please note that the handicap user apps and handicap user facing helper apps are closed apps that do not expose the user to any other native tablet functions other than the functions that these apps provide.

In the accessibility UI apps, default settings can be different from the MFD UI defaults since the accessibility UI is intended to serve a different set of users. This allows the unique capabilities of the MFD that are most beneficial to handicapped users can be utilized with minimum effort and knowledge of their existence. For example, searchable PDF is selected by default for Email app and the “To:” and “From:” fields are automatically populated with the user's email address. A document scanned with the Email app can go directly to a blind user and can be readable by a screen reader when it reaches the blind user's email account.

Besides using the touch screen with the Talkback accessibility functionality, a blind or visually impaired person can use an attached keyboard to navigate through the apps and selectable items. The table below shows how a user can navigate the Accessibility UI via the keyboard. There are two groups of keyboard functions. The Esc, Enter, Tab and Tab+Shift keys provides the navigation between apps and selectable items. The Left Arrow, Right Arrow, Back and Delete keys provides the editing functions within an alphanumeric entry field. Please note that these are exemplary examples. More keyboard functions such as hot keys can be added to further improve usability of the keyboard for handicapped users.

| KEY | NAVIGATION FUNCTIONS | TALKBACK |
|---|---|---|
| Esc | Return to previous screen, applies to | Same as when using |
| (escape) | pop up as well. | touch/finger navigation. |
| Enter | Is same as double tap for a selection | Same as when using |
| | when in talkback mode. | touch/finger navigation. |
| Tab | Navigate to the next editable/settable | Same as when using |
| | item, in the order left to right and top | touch/finger navigation. |
| | to bottom. | |
| Shift + | Navigate in reverse. (bottom up, right | Same as when using |
| Tab | to left) | touch/finger navigation. |
| Top | Navigate within field while editing. | When successful |
| arrow | Move to line above in the field, to the | announce “up” |
| | closest character position. | |
| Down | Navigate within field while editing. | When successful |
| arrow | Move to line below in the field, to the | announce “down” |
| | closest character position. | |
| Left | Navigate within field while editing. | Read out the character |
| arrow | Move over the character to the left of | passed over |
| | the cursor. | |
| Right | Navigate within field while editing. | Read out the character |
| arrow | Move over the character to the right | passed over |
| | of the cursor. | |
| Back | Deletes the character to the left | Announce the character |
| | of the cursor. | deleted when successful |
| Delete | Deletes the character to the | Announce the character |
| | right of the cursor. | deleted when successful |

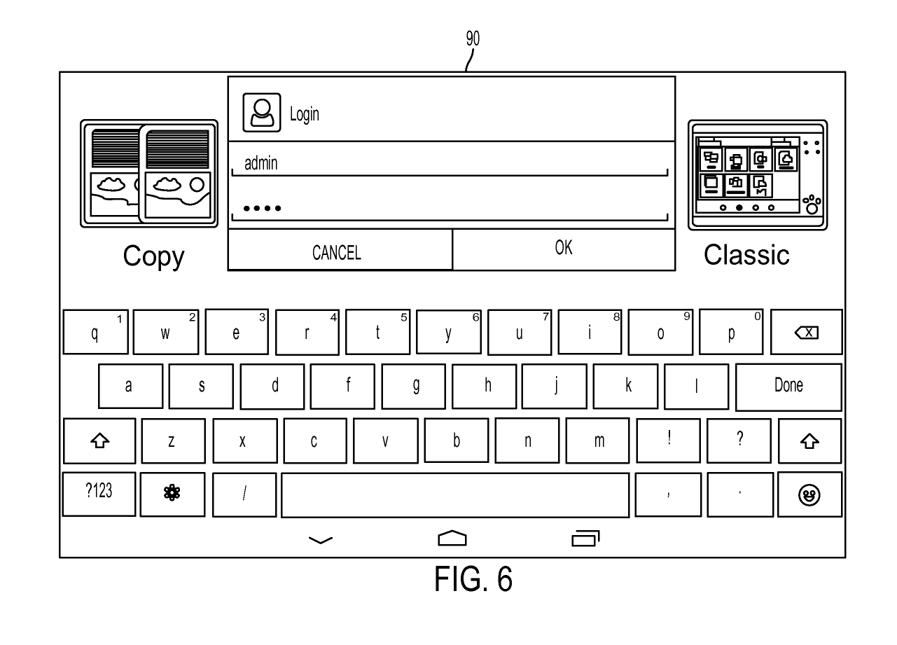

Finally, there are tablet set up and MFD maintenance apps. According to an exemplary embodiment of this disclosure exemplary embodiment, a Device app is included that allows an administrator or service engineer of the MFD to set up and/or have full access to the tablet and its functionalities. The system admin or service engineer will have to login to gain access. FIG. 6 shows an example of an admin log in screen.

Aspects and features of the disclosed embodiments include:

Using a tablet that is connected directly to a MFD as a UI where the accessibility UI is implemented as individual apps connected by well-defined interfaces.

The UI default values on the MFD are different for the optional accessibility UI where the default values are selected to be beneficial to the handicap user.

Simple key entries are used on an external keyboard to navigate and enter data to the Accessibility UI apps.

Voice command to launch a service app and corresponding functions.

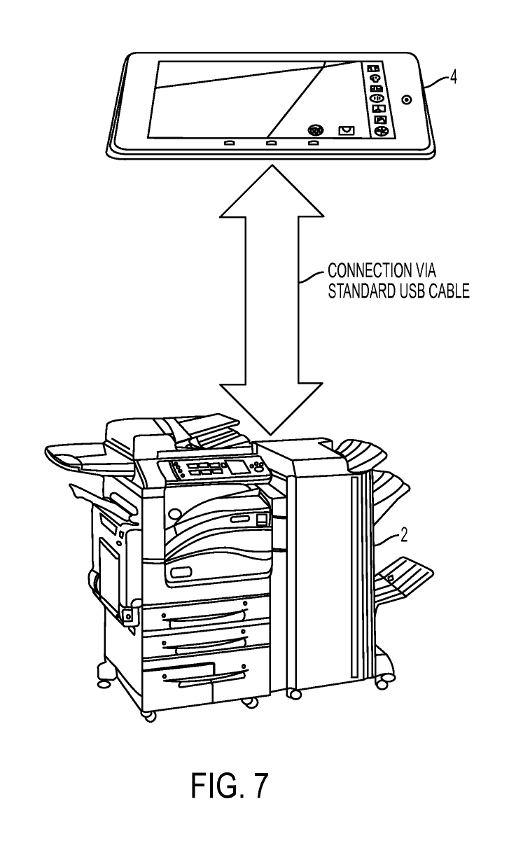

With reference to FIGS. 7-9, described is a hardware and basic connection approach for an Accessibility User Interface—describing the use of a bracket for mounting as option, tablet, USB, TCP/IP over USB, use of web services/network calls, etc. In addition, described below is a method and system using an Android© tablet as an Accessibility UI. An Android© tablet 4 is connected to an MFD 2 via a standard USB connection. A private network connection is established between the MFD and the Android© tablet over the USB interface. Standard web service and network calls that would normally be used in Wi-Fi or Ethernet connections is used for two way communications between the tablet and MFD. A USB hub is used whereby other peripherals, such as keyboard and secure card readers can be connected.

FIG. 7 shows a schematic of a basic connection of the Android@ tablet to the MFD. The Android© tablet runs the Accessibility UI SW that interacts with the MFD. Only a single USB cable is needed for the HW connection.

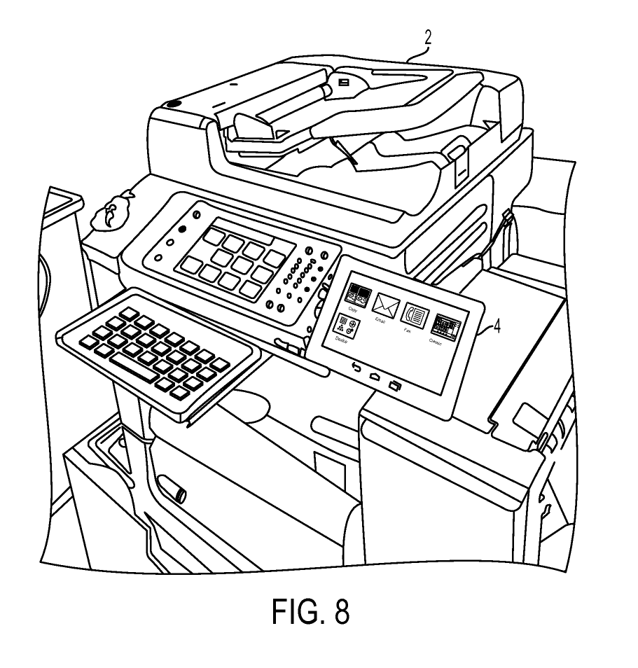

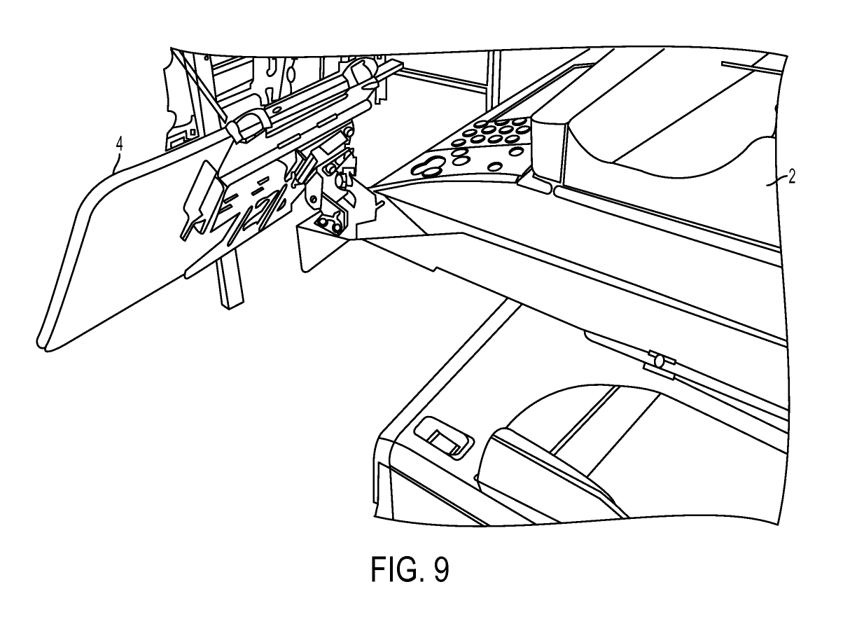

FIGS. 8 and 9 are the two views of the Accessibility UI as it is attached to the MFP via an add-on bracket. Note that the USB cable attachment is not shown in these pictures.

With the rapid evolution and adoption of the mobile devices, many user interaction interfaces are made available at very low cost. Interfaces such as microphone, speaker, capacitive touch screen, keyboards, etc., are commonly supported. Many tablet features/functions are enabled for the interfaces to enable ease of use of the tablets including for the handicap users.

For example, iOS® has VoiceOver© and Android© has Talkback© to assist blind and visually impaired user to navigate and use apps on their respective mobile platforms. Both iOS® and Android© devices support triple-tapping to magnify the current screen with full pinching to magnify and multiple finger gestures to scroll around the screen.

Rather than creating a custom interface to connect the Android© tablet to the MFD, the standard USB interface is used. The MFD is connected via a Remote Network Driver Interface Specification (RNDIS) driver to enable Ethernet network communications over the USB interface (see Wikipedia—Ethernet over USB; en.wikipedia.org/wiki/Ethernet_over_USB). On the Android© side, a USB tethering feature is used. Typically usage of USB tethering on an Android© is for an attached device such as a PC to access the internet via the Android's© cellular or Wi-Fi connection, e.g., see 5 Free Android Apps to Tethering; mashable.com/2012/08/16/free-tethering-apps/.

As described earlier, references to tethering for the Android© all seems to be geared towards sharing of the Android's© connectivity capability, generally, its cellular network (see “All you need to know about tethering with your Android© device”, www.androidauthority.com/what-is-tethering-android-280456/; “What is Tethering? [Android A to Z]”, www.androidcentral.com/what-tethering-android-z; and “Wikipedia Tethering”, en.wikipedia.org/wiki/Tethering). Standard network protocol such as DHCP (Dynamic Host Configuration Protocol) can be used by the MFP to request an IP address from the Android© tablet (see Dynamic Host Configuration Protocol; en.wikipedia.org/wiki/Dynamic_Host_Configuration_Protocol). However, in this application, tethering is used to establish a private network between the Android© to the MFP. Whereby, with the network connection, Android© apps can be developed to make use of standard TCP/IP (Transmission Control Protocol) based network calls such as Xerox EIP Web Service, VNC (Virtual Network Computing) Remote Frame Buffer protocol, SNMP (Simple Network Management Protocol), etc. to create UIs to interact with the MFP.

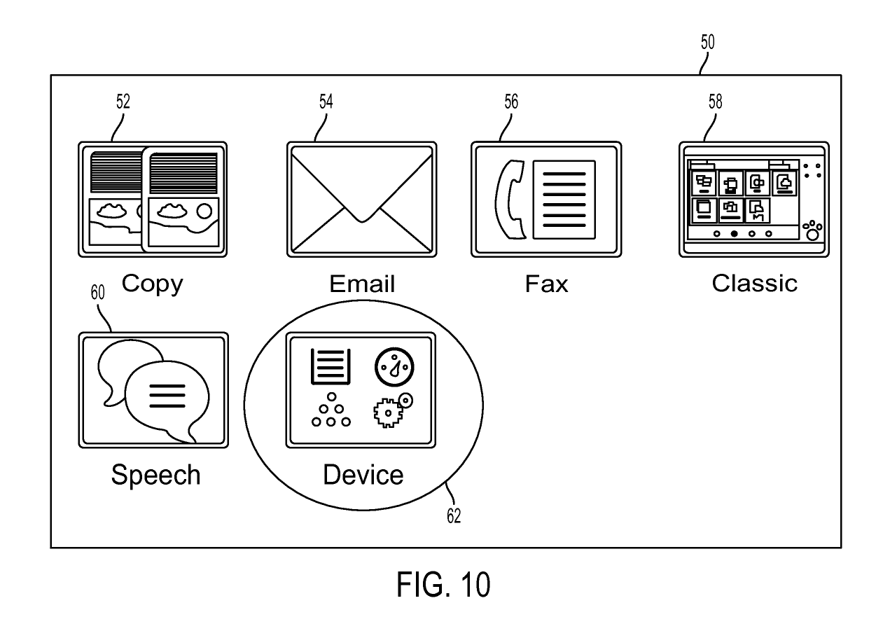

With reference to FIGS. 10-12, described now are Administrator Access and Root Access provided by the Accessibility UI described herein, according to an exemplary embodiment of this disclosure.

With reference to FIG. 10, illustrated is a home screen 50 associated with an Accessibility UI according to an exemplary embodiment of this disclosure, where a Device Application is launched by a user.

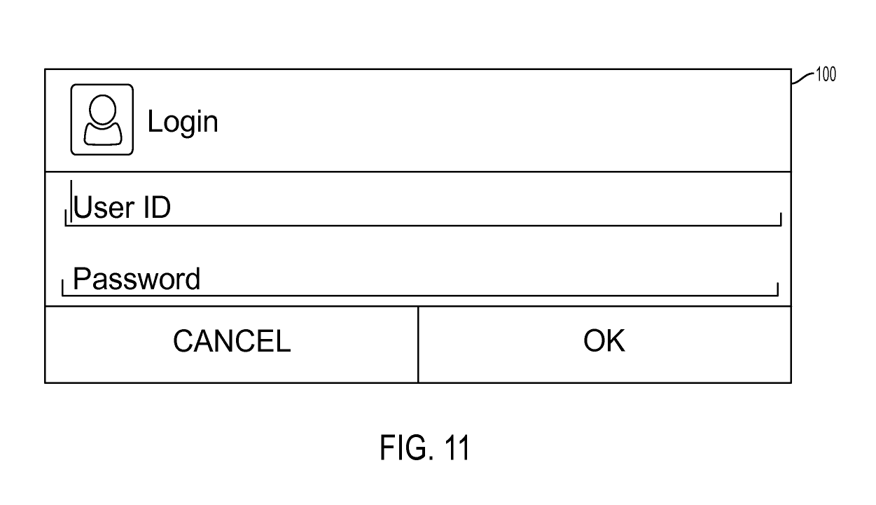

When the user selects the “Device” icon 62, a login popup window is displayed, as shown in FIG. 11.

An administrator login 100 provides a user, for example, with access to view a web user interface associated with the MFD, change the administrator password, enable/disable the tablet Talkback function to meet the needs of the users and view the versions of accessibility components installed on the Accessibility UI.

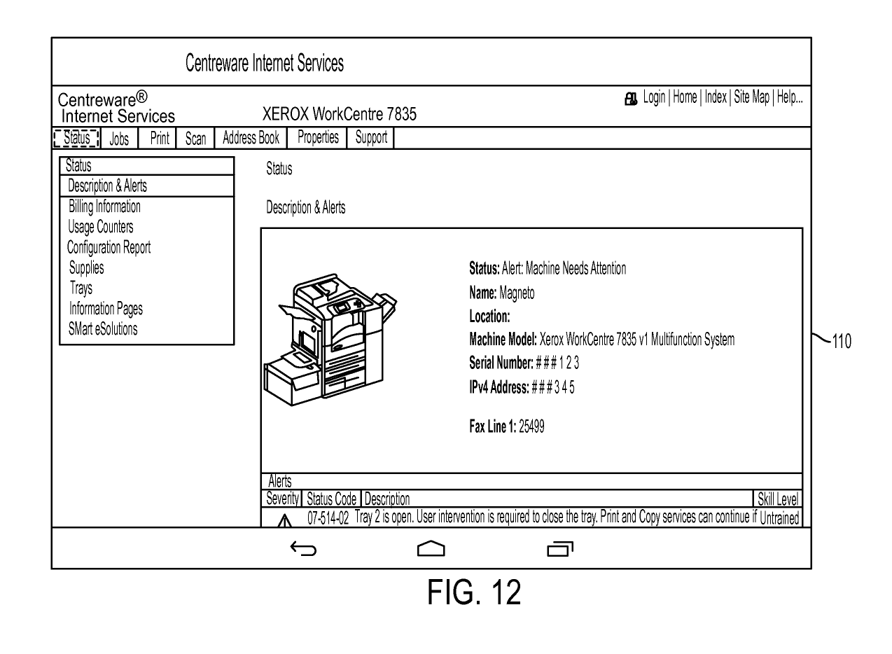

The web user interface 110 of the MFD, as shown in FIG. 12, is accessible by a user with Administrator privileges, via the Accessibility UI. This is in contrast to the normal operational mode of the MFD, where the web user interface is accessed using a computer browser. Using the Device Portal a system administrator is able to access all configurations and settings conveniently at the MFD.

A Root login provides a user with access to the MFD web user interface, access/control of the IP address used to connect the MFD, enable/disable the tablet, native Wi-Fi function or any other tablet native functions, access table native “settings” and view versions of the accessibility components installed on the Accessibility UI.

Root access is required to configure the portable computing device, i.e., tablet, serving as a supplemental UI/Accessibility UI. In other words, a root privileged user has access to the native platform associated with the tablet or other portable computing device serving as an Accessibility UI.

Accessibility of a Root user to the native platform of the Accessibility UI enables the root user to configure the Accessibility UI platform settings to select/deselect the container application providing the home screen and associated container applications previously described.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method of operating a multifunction printer (MFD) including one or more of a copy function, scanner function, email function, fax function, and print function, the MFD including a primary user interface (UI) and a portable computing device functioning as a supplemental UI operatively associated with the primary user interface, the method comprising:
operatively connecting the portable computing device to the MFD; and
the portable computing device displaying a home screen associated with a container application, the container application including the home screen and a collection of applications associated with one or more of the copy functions, scanner functions, email functions, fax functions, and print functions;
wherein the container application is configured to provide a user with no access to other functions of the portable computing device not associated with the container application.

2. The computer-implemented method of operating a MPD according to claim 1, wherein one or more of the container application functions are executable using one or more of a speech application, audible instruction application, and limited dexterity application.

3. The computer-implemented method of operating a MFD according to claim 1, wherein the container application includes a Device Application and the Device Application includes one or more user access levels.

4. The computer-implemented method of operating a MFD according to claim 1, wherein the container application includes a Classic View Application and the Classic View Application includes UI identical to the UI provided by the Primary UI.

5. The computer-implemented method of operating a MFD according to claim 1, wherein the portable computing device is one of a computer tablet, a laptop computer, and a mobile phone.

6. The computer-implemented method of operating a MFD according to claim 1, wherein the mobile computing device includes one of an android based operating system and an IOS based operating system.

7. The computer-implemented method of operating a MFD according to claim 1, wherein default operating parameters associated with the portable computing device include one or more of voice instruction, Talkback, double sided scanning, Double Tapping, and scan to email.

8. The computer-implemented method of operating a MFD according to claim 1, wherein the portable computing device is operatively connected to the MFD using one of a USB port, TCP/IP over USB, and a wireless network.

9. A multifunction device (MFD) comprising:
a primary user interface (UI) configured to provide a user with control of one or more of a copy function, scanner function, fax function, and print function;
one or more processers and associated memory configured to execute the one or more of the copy function, scanner function, fax function, and print function;
a portable computing device operatively associated with the MFD, the portable computing device configured to display a home screen associated with a container application, the container application including the home screen and a collection of applications associated with one or more of the copy function, scanner function, email function, fax function, and print function,
wherein the container application is configured to provide the user with no access to other functions of the portable computing device not associated with the container application.

10. The MFD according to claim 9, wherein one or more of the container application functions are executable using one or more of a speech application, audible instruction application, and limited dexterity application.

11. The MFD according to claim 9, wherein the container application includes a Device Application and the Device Application includes an Administrator Access Level and a Root Access Level.

12. The MFD according to claim 9, wherein the container application includes a Classic View Application and the Classic View Application includes UI identical to the UI provided by the Primary UI.

13. The MFD according to claim 9, wherein the portable computing device is one of a computer tablet, a laptop computer, and a mobile phone.

14. The MFD according to claim 9, wherein the mobile computing device includes one of an android based operating system and an IOS based operating system.

15. The MFD according to claim 9, wherein default operating parameters associated with the portable computing device include one or more of voice instruction, Talkback, double sided scanning, Double Tapping, and scan to email.

16. The MFD according to claim 9, wherein the portable computing device is operatively connected to the MFD using one of a USB port, TCP/IP over USB, and a wireless network.

17. A portable computing device operatively associated with a multifunction device (MFD) including one or more of a copy function, scanner function, email function, fax function, and print function, the portable computing device comprising:
one or more processors and operatively associated memory storing instructions to the one or more processors configured to execute the stored instructions to display a home screen associated with a container application, the container application including the home screen and a collection of applications associated with one or more of the copy function, scanner function, email function, fax function, and print function;
wherein the container application is configured to provide a user with no access to other functions of the portable computing device not associated with the container.

18. The portable computing device according to claim 17, wherein one or more of the container application functions are executable using one or more of a speech application, audible instruction application, and limited dexterity application.

19. The portable computing device according to claim 17, wherein the container application includes a Device Application and the Device Application includes one or more user access levels.

20. The portable computing device according to claim 17, wherein the portable computing device is one of a computer tablet, a laptop computer, and a mobile phone.
